(19) United States
(12) Patent Application Publication
(10) Pub. No.: US 2013/0159411 A1
(43) Pub. Date: Jun. 20, 2013

(54) DATA SHARING AND CONTENT DELIVERY SYSTEM

(71) Applicant: Barbara Bowen, Shakopee, MN (US)

(72) Inventor: Barbara Bowen, Shakopee, MN (US)

(21) Appl. No.: 13/667,888

(22) Filed: Nov. 2, 2012

Related U.S. Application Data
(60) Provisional application No. 61/554,753, filed on Nov. 2, 2011.
(60) Provisional application No. 61/558,916, filed on Nov. 11, 2011.

(51) Int. Cl. H04L 29/08

(52) U.S. Cl. CPC H04L 67/22
USPC 709/204

(57) ABSTRACT

The present disclosure relates to a personal data cooperative system for use by an organization or group that will develop a technology framework to support the storage, identity, authentication, aggregation, exchange, and monetization of personal data including data dividends based on advertising revenues that benefit a user's membership base, and address privacy and portability issues. The present disclosure further relates to a media content delivery system that provides secure and seamless media and entertainment experiences on connected customer devices with encrypted API integration for media servers, storage and commerce. The proliferation of devices and media sources are connected in the system as disclosed to provide customers an efficient yet entertaining user experience through access to content and commerce.

### CROSS-REFERENCE TO RELATED APPLICATIONS

This application claims the benefit of U.S. Provisional Application Ser. No. 61/554,753, titled PERSONAL DATA COOPERATIVE SYSTEM, filed Nov. 2, 2011, and further claims the benefit of U.S. Provisional Application Ser. No. 61/558,916, titled MEDIA CONTENT DELIVERY SYSTEM AND METHOD, filed Nov. 11, 2011.

### SUMMARY

The present disclosure relates to a personal data cooperative system for use by an organization or group that will (a) develop a technology framework to support the storage, identity, authentication, aggregation, exchange, and monetization of personal data including data dividends based on advertising revenues that benefit a user's membership base and (b) address privacy and portability issues.

The present disclosure further relates to a media content delivery system that provides secure and seamless media and entertainment experiences on connected customer devices with encrypted API integration for media servers, storage and commerce. The proliferation of devices and media sources are connected in the system as disclosed to provide customers an efficient yet entertaining user experience through access to content and commerce.

Various embodiments of the present invention will be described in detail with reference to the drawings. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover applications or embodiments without departing from the spirit or scope of the claims attached hereto. Also, it is to be understood that the phraseology and terminology used herein are for the purpose of description and should not be regarded as limiting.

### BRIEF DESCRIPTION OF THE DRAWINGS

FIG. 1 is a diagram illustrating how the disclosed personal data cooperative system works with existing data systems according to one embodiment of the present invention.

FIG. 2 is a diagram illustrating networks of the disclosed media content delivery system in use with connected computing devices according to one embodiment of the present invention.

### PERSONAL DATA COOPERATIVE SYSTEM

### Background

The disclosed data cooperative is related to a model for data banking with user-centric benefits. As there are ever-increasing amounts of personal information online, the cooperative system will consist of member-owned data lockers and services which provide member security and exchange with economic dividends. The disclosed cooperative system will secure the digital assets of the member bases of organizations and groups using the system and promote exchanges with data apps and services.

### Detailed Description

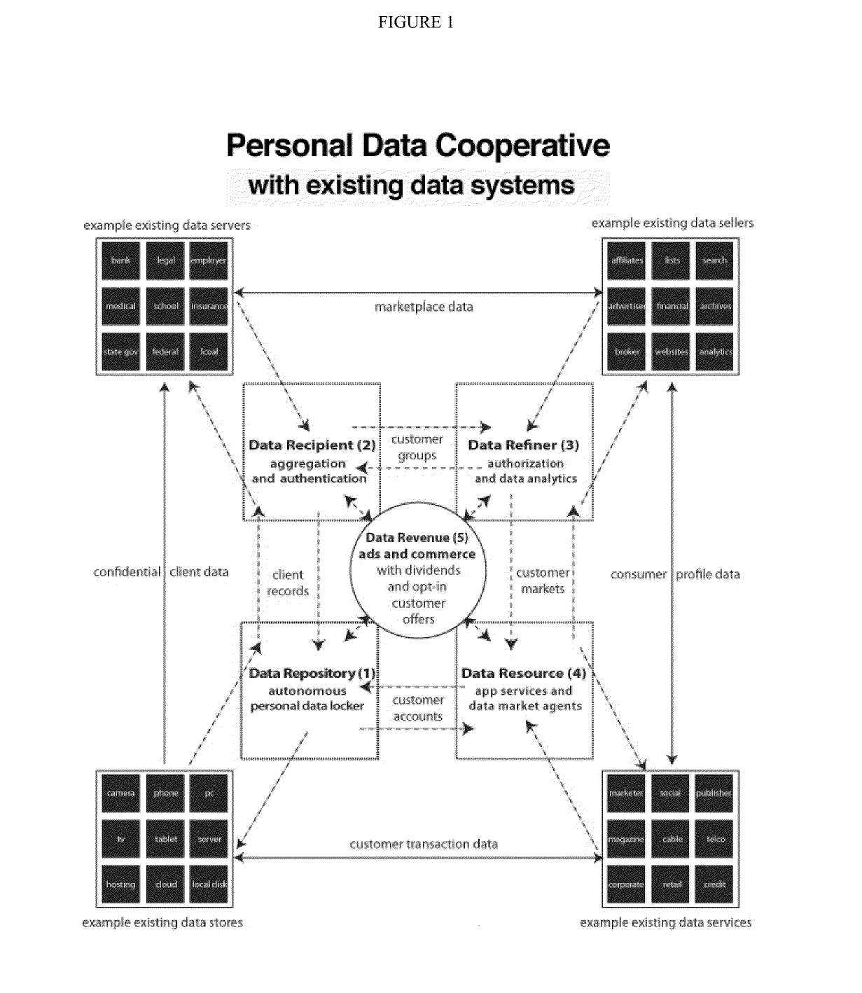

The following description makes reference to the alpha-numeric identifiers included in the accompanying FIG. 1. For a better understanding of the present disclosure, reference should be made to the accompanying FIG. 1 and descriptive matter in which there is illustrated an exemplary embodiment of the present disclosure.

The Data Repository (1) is a user-managed portable data locker featuring privacy and anonymization of personal information. This element will integrate a variety of social data and transactional information in a portable format that is autonomous and controlled by each member. With encoded security features, it acts as a secure personal data deposit box.

The Data Recipient (2) is an aggregated member services data center allowing exchanges with new and existing services including, but not limited to: sharing between members, personal profile management, group exchanges, collaborative work, social networking services, customer collaboration, media sharing, video conferencing, audio library, educational seminars, comments, reviews, ratings, network credits, online payments, trust frameworks, identity authentications, transaction verification, community sharing, group deals, auctions, chats, video viewing, financial services, dividends, cloud storage, and search settings.

The Data Recipient (2) includes a personal encoded archive with the ability to download information to or upload information from the Data Repository (1). The Data Recipient (2) is also authorized for aggregation and verification as trust agent for marketplace: Data Refiner (3).

The Data Refiner (3) is an opt-in cooperative marketplace that allows commercial vendors and service providers to conduct analytics and transactional data access with member-centric permissions including data authentication and anonymize features, and gives said vendors and service providers access to customer communication. There are unlimited combinations of customer data profiles that can be customized and served to the Customer Relationship Management industry based on cooperative member parameters and privacy settings.

The Data Refiner (3) allows data and Application Programming Interface (API) access for developers of apps and service providers within Data Resource (4).

Data Resource (4) is the development platform for app creators and data services. Providers will access APIs from both the Data Refiner (3) and from individuals based on privacy settings and data preferences on the personal Data Repository (1). Data Resource (4) has access to managed campaigns in the dividend marketplace and ad services of Data Revenue Center (5).

The Data Revenue Center (5) is comprised of advertising and marketing services that are optional for the member base and may provide dividends based on parameters agreed upon between transactional parties. This marketplace will be open to all the components of the cooperative network to allow, for example, a variety of incentives, offers, deals, focus groups, coupons, classified ads, display ads, inline video ads, sponsorships and promotions of goods and services.

### Examples of System Usage

The following Action Types 1 through 5 demonstrate some examples of how the disclosed personal data cooperative system can be used by customers. Reference should be made to the accompanying FIG. 1 to provide further understanding of these examples.

Action Type 1: A customer creates, tags, and edits video of a concert performance with a mobile device. The customer uploads the video to his/her personal Data Repository (1) for storage. The customer authorizes video release to Data Recipient (2) for entry into a video contest seen in a music publication. The video place, time, performance, and creator data are authenticated through the Data Recipient (2). Anonymized customer data and video files are released to the publisher's server. The customer can also choose to receive opt-in offers from the music publication and its advertisers (see Action Type 3).

Action Type 2: A customer wins a $500.00 contest prize and payment is made by the contest publisher to the customer's account at Data Recipient (2). Data Recipient (2) issues winning prize notice to customer's Data Repository (1). The customer is then notified by an authenticated email of their winning entry through the customer's Data Repository (1). The customer authorizes Data Recipient (2) to deposit prize money into the customer's bank account in a secured transaction.

Action Type 3: Authorized group data demographics are provided to an advertiser by the Data Refiner (3). The advertiser creates several versions of targeted ads based on analytics obtained from Data Refiner (3). The advertiser provides the promotional files to servers of a Data Revenue Center (5). Offers are generated by a Data Revenue Center (5) and sent to a customer's Data Repository (1). The Data Repository (1) recognizes authorized opt-in offers and sends a digital coupon to the customer's mobile device.

Action Type 4: A customer decides to download an app from a Data Resource (4) provider. The customer shares video on the band's network app where the customer has a custom profile and privacy settings. By permission, the customer has chosen to share video with the band, concert promoters, and other fans through the app. No personal information is shared across the app, but a concert promoter would like to use the customer video. The marketing agency used by the concert promoter contacts the Data Resource (4). Data Resource (4) uses an API to transfer the concert promoter's offer to Data Revenue Center (5). The customer is notified of the promoter's offer via a secure email account in Data Repository (1). The customer accepts the promoter's offer through Data Revenue Center (5). The promoter is granted API access to Data Revenue Center (5), and the promoter transfers a VIP ticket package to the customer through the Data Revenue Center (5). Electronic tickets are transferred to the Data Repository (1), and the customer can download the tickets to their personal computer and print the tickets for admission to the VIP event.

Action type 5: A band offers concert merchandise to fans using an affiliate program that integrates group offers with Data Refiner (3). Data Refiner (3) serves e-commerce information to the band's network app as a Data Resource (4) provider. The customer views merchandise on an app served by Data Resource (4); the app also accepts customer dividends payment. The customer redeems dividends to order a concert T-shirt and authorizes shipping information at Data Repository (1). Data Repository (1) authorizes payment to the app as Data Resource (4) through the Data Revenue Center (5).

### Media Content Delivery System

### Detailed Description

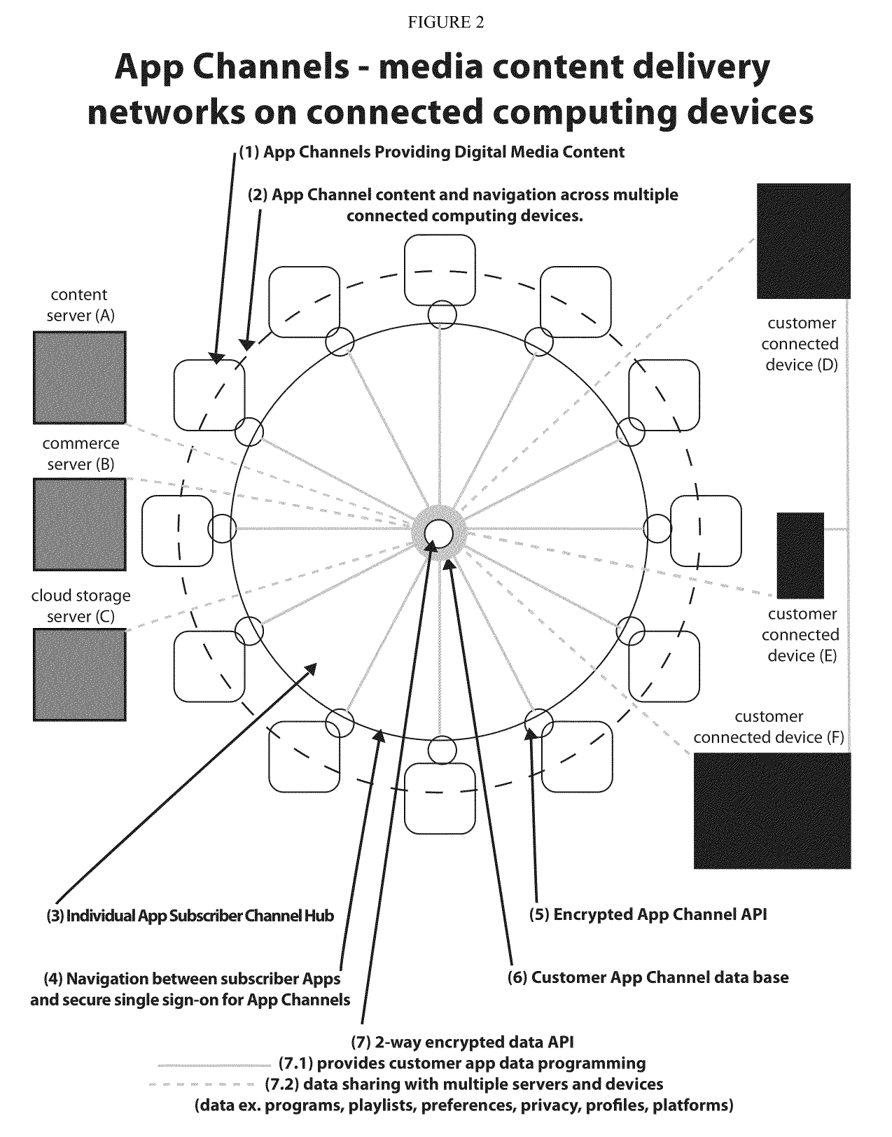

The following description makes reference to the alpha-numeric identifiers included in the accompanying FIG. 2. For a better understanding of the present disclosure, reference should be made to the accompanying FIG. 2 and descriptive matter in which there is illustrated an exemplary embodiment of the present disclosure.

(1) The disclosed system providing digital media content on connected customer devices such as TV, mobile, tablet, and PC.

(2) The system's content and navigation across multiple connected computing devices with the ability to create, save and compare custom preferences across the network or on each connected computing device.

(3) Individual app subscriber channel hub that is accessed through the internet or connected customer devices or cloud servers.

(4) Navigation between subscriber apps and secure single sign-on for the disclosed system provides streamlined access to content with customer settings delivering relevant media and playlists.

(5) Encrypted system API allows unique user names on each app channel (hereafter “channel”) and creates a secure data point.

(6) Customer's database within the system server stores preferences and privacy settings along with media sharing.

(7) Two-way encrypted data API ensures programming and media sharing security between system server, devices, and other servers. Encryption keys for network nodes are a unique way to secure data endpoints and support hash tables for connected data nodes, and identity lookup schema of Oauth protocol.

### Examples of System Usage

(1) Channel subscription is initiated by a customer at (3) app subscriber hub with devices (D), (E), (F).

12 different (1) content channels are selected by the customer with (4) secure single sign-on access.

Each of the customer's chosen channels is then assigned a unique (5) encrypted system API within the network.

The customer programs each (1) channel with custom preferences with (6) data settings (for example: programs, playlists, preferences, privacy, profiles, platforms, opt-in promotions, etc.).

The customer enjoys media content on a variety of connected devices (D), (E), (F) with seamless (4) system navigation.

Customer interactions on the network through devices (D), (E), (F) are authorized through (7.2) two-way encrypted API and recorded in (6) customer database.

(A) (B) (C) Content, Commerce and Cloud Storage Servers are authorized through (7.2) 2-way encrypted data API and media is stored or shared through (6) customer database.

Customer may choose data programming with (7.1) two-way API settings to engage with media, ecommerce, or advertising programs.

### System Technical Components

The disclosed personal data cooperative and media content delivery systems are computer-implemented and use a computing system including at least one computing device. In some embodiments the computing system further includes a communication network and one or more additional computing devices (such as a server).

The computing device can be a stand-alone computing device or a networked computing device that communicates with one or more other additional computing devices across a network. The additional computing device(s) can be, for example, located remote from the initial computing device, but configured for data communication with the initial computing device across a network.

In some examples, the computing device includes at least one processor or processing unit and system memory. Depending on the exact configuration and type of computing device, the system memory may be volatile (such as RAM), nonvolatile (such as ROM, flash memory, etc.) or some combination of the two. System memory typically includes an operating system suitable for controlling the operation of the computing device, such as the WINDOWS® operating systems from Microsoft Corporation of Redmond, Wash., or a server, such as Windows SharePoint Server, also from Microsoft Corporation. The system memory may also include one or more software applications and may include program data.

The computing device may have additional features or functionality. For example, the device may also include additional data storage devices (removable and/or non-removable) such as, for example, magnetic disks, optical disks, or tape. Computer storage media may include volatile and nonvolatile, removable and non-removable media implemented in any method or technology for storage of information, such as computer readable instructions, data structures, program modules, or other data. System memory, removable storage and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media is non-transitory media.

In some examples, one or more of the computing devices can be located in an organization or group's place of business. In other examples, the computing device can be a personal computing device that is networked to allow the user to access the cooperative system disclosed herein at a remote location, such as in a user's home or other location. In some embodiments, the computing device is a smart phone or other mobile device. In some embodiments some components of the disclosed system are stored as data instructions for a Smartphone application. A network facilitates communication between the computing device and one or more servers, such as an additional computing device, that host the disclosed system. The network may be a wide variety of different types of electronic communication networks. For example, the network may be a wide-area network, such as the Internet, a local-area network, a metropolitan-area network, or another type of electronic communication network. The network may include wired and/or wireless data links. A variety of communications protocols may be used in the network including, but not limited to, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device is a Web server. In this example, the initial computing device includes a Web browser that communicates with the Web server to request and retrieve data. The data is then displayed to the user, such as using a Web browser software application.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A system for sharing user data, wherein a plurality of users can create user accounts, upload or connect external user data to their user accounts, and share user data from their user accounts with other users, the system comprising:
a computer network for management and transmission of user data;
a data storage device for storing user data;
a server configured to receive user data; and
a plurality of computing devices configured to transmit user data.

2. The system of claim 1, wherein the user data may include one or more of the following: personal data, medical data, financial data, purchase history, internet search history, artistic works, or photographs.

3. The system of claim 1, wherein the system is configured to permit statistical analysis of user account data from one or more users.

4. The system of claim 3, wherein the system is configured to present new content to a user based on statistical analysis of the user's account data.
